(19) United States
(12) Patent Application Publication
(10) Pub. No.: US 2024/0386473 A1
(43) Pub. Date: Nov. 21, 2024

(54) SYSTEM AND METHOD FOR PREDICTING THE DESIRE TO KEEP THE DOOR OPEN WHEN MAKING DECISIONS

(71) Applicant: TOYOTA RESEARCH INSTITUTE, INC., Los Altos, CA (US)

(72) Inventors: Francine R. CHEN, Menlo Park, CA (US); Kenton Michael LYONS, Los Altos, CA (US); Totte Harri HARINEN, Sunnyvale, CA (US); Alexandre Leo Stephen FILIPOWICZ, Mountain View, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/319,416

(22) Filed: May 17, 2023

(51) Int. Cl. G06Q 30/0601

(52) U.S. Cl. CPC G06Q 30/0631; G06Q 30/0633

(57) ABSTRACT

A method for monitoring user purchase making activity is described. The method includes logging a potential user purchase and purchase communications corresponding to a potential option available for purchase by a user. The method also includes predicting whether loss aversion is a factor in a purchase making process of the potential option available for purchase by the user. The method further includes determining a purchase recommendation in response to identifying that the loss aversion is the factor in the potential purchase making process of the potential option available for purchase by the user. The method also includes displaying the purchase recommendation based on a use frequency of the option purchased by the user.

### BACKGROUND

### Field

Certain aspects of the present disclosure generally relate to machine learning and, more particularly, to a system and method for predicting the desire to keep the door open when making decisions.

### Background

Decision makers are often faced with the challenge of choosing among several options. These decision makers may have a tendency to invest time and money to keep their options open, even when the options have little interest or are unlikely to be used. This behavior may be attributed to loss aversion. For example, buying something with more features than you need in case you may need it in the future may be attributed to loss aversion (e.g., an expandable computer system or all-wheel drive, in case you need to drive to a snowy location). Other examples include: (a) whether to buy a system that suits their current needs or to purchase an expandable system or (b) whether to buy an extended warranty.

Nevertheless, the influence of loss aversion on decision making can vary and is not applicable to all decisions. For example, when deciding on which flight to take, some decision makers, such as business travelers, choose the flight with the most convenient schedule. Another example is when choosing to purchase something needed immediately, such as sunburn spray, keeping options open is not relevant if you have a painful sunburn. Additionally, when faced with many choices of an inexpensive item, many people decide not to make a choice (e.g., an experiment showed that more people made a purchase when choosing among only a few jams than when there was a selection of many jams). In some cases, it is important to keep an option available; that is, to keep the door open. In many other cases, it can be costly and unnecessary.

A system and method for predicting a decision maker's desire to keep the door open and, secondarily, to advise the decision maker on how likely the option will be useful is desired.

### SUMMARY

A method for monitoring user purchase making activity is described. The method includes logging a potential user purchase and purchase communications corresponding to a potential option available for purchase by a user. The method also includes predicting whether loss aversion is a factor in a purchase making process of the potential option available for purchase by the user. The method further includes determining a purchase recommendation in response to identifying that the loss aversion is the factor in the potential purchase making process of the potential option available for purchase by the user. The method also includes displaying the purchase recommendation based on a use frequency of the option purchased by the user.

A non-transitory computer-readable medium having program code recorded thereon for monitoring user purchase making activity is described. The program code is executed by a processor. The non-transitory computer-readable medium includes program code to log a potential user purchase and purchase communications corresponding to a potential option available for purchase by the user. The non-transitory computer-readable medium also includes program code to predict whether loss aversion is a factor in a purchase making process of the potential option available for purchase by the user. The non-transitory computer-readable medium further includes program code to determine a purchase recommendation in response to identifying that the loss aversion is the factor in the potential purchase making process of the potential option available for purchase by the user. The non-transitory computer-readable medium also includes program code to display the purchase recommendation based on a use frequency of the option purchased by the user.

A system for monitoring user purchase making activity is described. The system includes a purchase logging module to log a potential user purchase and purchase communications corresponding to a potential option available for purchase by the user. The system also includes a loss averse purchase identification model to predict whether loss aversion is a factor in a purchase making process of the potential option available for purchase by the user. The system further includes a purchase advice determination model to determine a purchase recommendation in response to identifying that the loss aversion is the factor in the potential purchase making process of the potential option available for purchase by the user. The system also includes a purchase advice display module to display the purchase recommendation based on a use frequency of the option purchased by the user.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of a loss averse purchase monitoring and recommendation system, in accordance with aspects of the present disclosure.

FIG. 2 is a block diagram illustrating an exemplary software architecture that may modularize artificial intelligence (AI) functions for a loss averse purchase monitoring and recommendation system, according to aspects of the present disclosure.

FIG. 3 is a diagram illustrating a hardware implementation for a loss averse purchase monitoring and recommendation system, according to aspects of the present disclosure.

FIG. 4 is a block diagram illustrating a compromised decision monitoring and recommendation system, in accordance with aspects of the present disclosure.

FIG. 5 is a flowchart illustrating a method for monitoring user decision making activity, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Decision makers are often faced with the challenge of choosing among several options. These decision makers may have a tendency to invest time and money to keep their options open, even when the options have little interest or are unlikely to be used. This behavior may be attributed to loss aversion. For example, buying something with more features than you need in case you may need it in the future may be attributed to loss aversion (e.g., an expandable computer system or all-wheel drive, in case you need to drive to a snowy location). Other examples include: (a) whether to buy a system that suits their current needs or to purchase an expandable system or (b) whether to buy an extended warranty.

Nevertheless, the influence of loss aversion on decision making can vary and is not applicable to all decisions. For example, when deciding on which flight to take, some decision makers, such as business travelers, choose the flight with the most convenient schedule. Another example is when choosing to purchase something needed immediately, such as sunburn spray, keeping options open is not relevant if you have a painful sunburn. Additionally, when faced with many choices of an inexpensive item, many people decide not to make a choice (e.g., an experiment showed that more people made a purchase when choosing among only a few jams than when there was a selection of many jams). In some cases, it is important to keep an option available; that is, to keep the door open. In many other cases, it can be costly and unnecessary.

A system and method for predicting a decision maker's desire to keep the door open and, secondarily, to advise the decision maker on how likely the option will be useful is desired. Some aspects of the present disclosure are directed to a system and method that predicts a user's “loss aversion” when making a purchase and makes recommendations based on the predicted loss aversion.

There are different dimensions that can influence whether a decision maker will want to keep the door open. For some of the dimensions, loss aversion is a factor, while it is not for others. In some aspects of the present disclosure, the method first identifies a set of dimensions involved in decision-making. A model is then created, which takes the choices and uses values for the applicable dimensions as input. The model predicts the strength of a desire to keep the door open. If there is a strong desire to keep the door open, then the average use of the option can be presented to the decision maker. Some aspects of the present disclosure may implement one of several complementary data analysis methods to identify a set of dimensions related to whether loss aversion is a factor.

In some aspects of the present disclosure, a method may include examining social media for comments about features that a purchaser wishes for in their product. Features that a purchaser commonly expresses that they would like after purchasing a product are unlikely to be features characteristic of a door (feature) that one might want to keep open. The method may include examining a purchaser's feature choices by comparing features of past purchases to new purchases to provide insight to what features matter. For example, if a user previously purchased a car with a sunroof but their next car does not have a sunroof, a sunroof may have been purchased on the first car to keep the door open.

In some aspects of the present disclosure, the method may include examining a purchaser's feedback about deletion of a feature. For example, when a feature is removed from a product, the complaints in reviews about a product about the missing feature can be analyzed. If the missing feature was an option and there are few complaints about its removal, then the missing feature is likely needlessly purchased to keep the door open. The greater the number of complaints and the stronger the sentiment, the more likely the feature is associated with a dimension of loss aversion, and one would want to keep the door open. Similarly, examination of social media for comments about a feature when it is introduced, such as the presence of positive comments about a feature, may indicate that a potential purchaser is more likely to consider the feature as something for which they would like to keep the door open so that they have the option to try out the new feature.

Furthermore, the method may examine a purchaser's use of a feature through analysis of sources of information regarding the use of a feature after a purchase. For example, one version of a fitness tracker may offer a feature that tells you how long and how well you slept, while a more inexpensive version does not. For people who opt to purchase the fitness tracker with the sleep monitor, examination of how often the feature is used and whether it is used a month or so after purchase can indicate whether the feature was selected to keep the door open.

Other dimensions include the number of choices or extenuating circumstances, such as the need to immediately make a decision, could be directly included without the need to analyze data. Additionally, in some aspects of the present disclosure, a method may be configured to consider additional inputs such as price or frequency of purchase of a product as these may drive a desire to keep the door open. Accordingly, products can be classified to identify those that are of the type where the door is often kept open. Additionally, purchasers may also be inclined to keep the door open when making decisions regarding products that have multiple options and features. The systems and methods according to aspects of the present disclosure may obtain this information from sources that list tables of features, such as broadband packages, cars, and tables comparing features for some products (e.g., air fryer toaster ovens), on Internet sites.

Once estimates are computed for how often a purchaser “kept the door open” for features associated with different products, the input from the different estimates are combined to train a machine-learning model (e.g., a statistical model) to predict the probability that a potential purchaser will keep the door open on different features. Additionally, the trained machine-learning model can predict the frequency that an option is used and in response, present a recommendation to decision makers likely to unnecessarily keep the door open. In some aspects of the present disclosure, the recommendation can be an output in the form of an alert. The alert may indicate to the decision maker the frequency of use of contemplated features by other similarly situated purchasers.

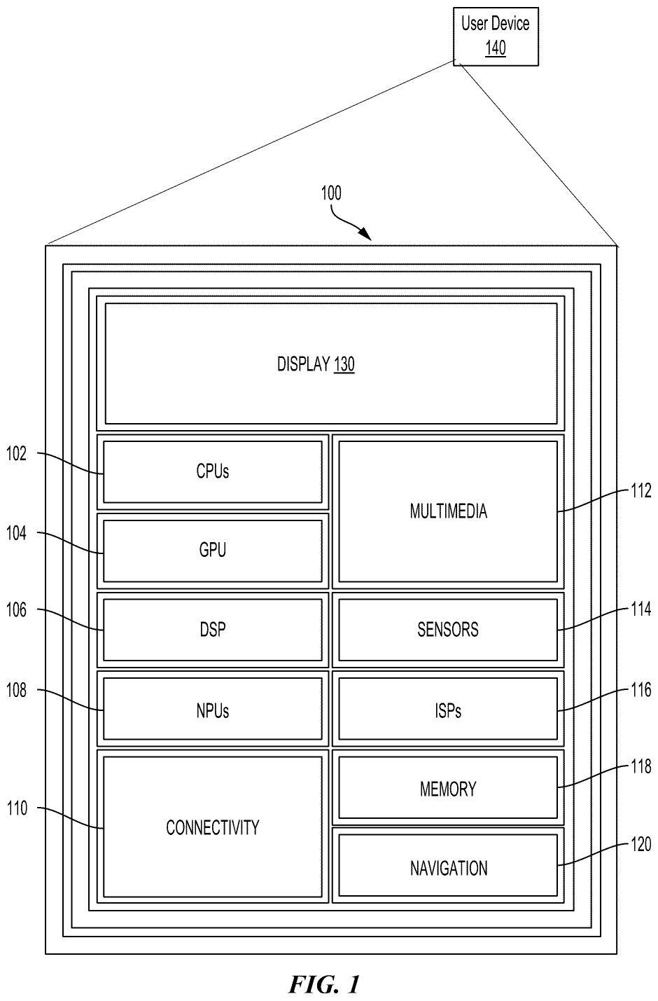

FIG. 1 illustrates an example implementation of the aforementioned system and method for a risk averse purchase monitoring and recommendation system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risk Machine (ARM) instruction set or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., CPU 102) or the NPU 108 of the user device 140 may include code to monitor potential user purchase making activity. The instructions loaded into a processor (e.g., CPU 102) may also include code to log a potential user purchase and purchase communications corresponding to a potential option available for purchase by the user. The instructions loaded into a processor (e.g., CPU 102) may also include code to identify whether loss aversion was a factor in a potential purchase making process of the potential option available for purchase by the user. The instructions loaded into a processor (e.g., CPU 102) may also include code to generate a purchase recommendation based on the average use of the potential option available for purchase by the user in response to identifying that loss aversion is a factor in the potential decision-making process of the option available for purchase by the user.

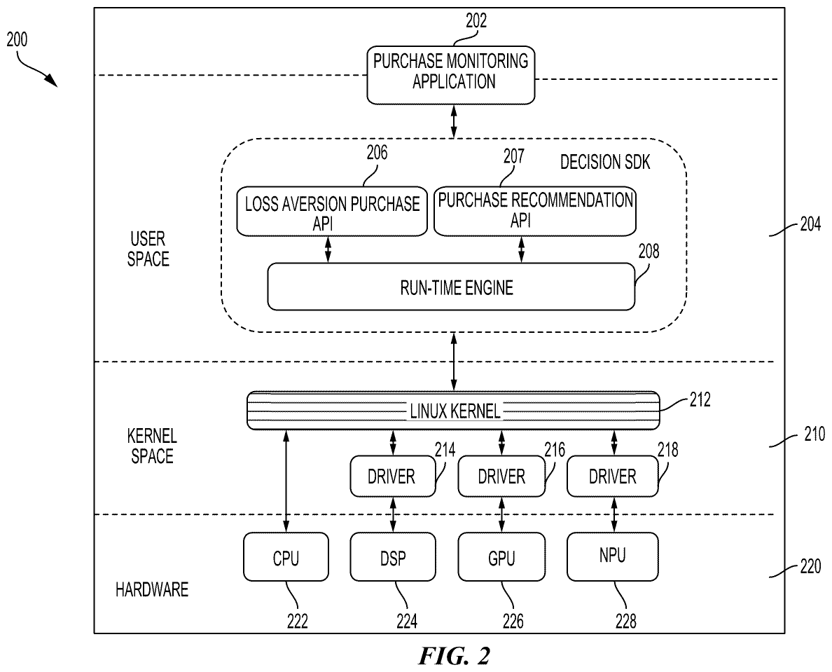

FIG. 2 is a block diagram illustrating a software architecture 200 that may modularize artificial intelligence (AI) functions for a loss averse purchase monitoring and recommendation system, according to aspects of the present disclosure. Using the architecture, a purchase monitoring application 202 may be designed such that it may cause various processing blocks of an SOC 220 (for example a CPU 222, a DSP 224, a GPU 226, and/or an NPU 228) to perform supporting computations during run-time operation of the purchase monitoring application 202. FIG. 2 describes the software architecture 200 for monitoring risk averse purchases and providing recommendations. It should be recognized that the risk averse purchase monitoring and recommendation system is not limited to purchases involving risk aversion. According to aspects of the present disclosure, the risk averse purchase monitoring and recommendation functionality is applicable to any type of purchase or user activity.

The purchase monitoring application 202 may be configured to call functions defined in a user space 204 that may, for example, provide for user purchase activity and purchase monitoring services. The purchase monitoring application 202 may make a request for compiled program code associated with a library defined in a loss aversion purchase application programming interface (API) 206. The loss aversion purchase API 206 is configured to log a user purchase and purchase communications corresponding to an option purchased by the user. The loss aversion purchase API 206 is further configured to identify whether loss aversion was a factor in a purchase making process of the user purchase of the option. In response, compiled code of a purchase recommendation API 207 is configured to generate a purchase recommendation based on the average use of the option in response to identifying that loss aversion is a factor in the decision-making process of the user purchase of the option.

A run-time engine 208, which may be compiled code of a run-time framework, may be further accessible to the purchase monitoring application 202. The purchase monitoring application 202 may cause the run-time engine 208, for example, to take actions for providing purchase recommendations in response to risk averse user purchases. In response to detection of a risk averse user purchase, the run-time engine 208 may in turn send a signal to an operating system 210, such as a Linux Kernel 212, running on the SOC 220. FIG. 2 illustrates the Linux Kernel 212 as software architecture for risk averse purchase monitoring and recommendation. It should be recognized, however, that aspects of the present disclosure are not limited to this exemplary software architecture. For example, other kernels may provide the software architecture to support risk averse purchase monitoring and recommendation functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

Decision makers are often faced with the challenge of choosing among several options. These decision makers may have a tendency to invest time and money to keep their options open, even when the options have little interest or are unlikely to be used. This behavior may be attributed to loss aversion. For example, buying something with more features than you need in case you may need it in the future may be attributed to loss aversion (e.g., an expandable computer system or all-wheel drive in case you need to drive to a snowy location). Other examples include: (a) whether to buy a system that suits their current needs or to purchase an expandable system or (b) whether to buy an extended warranty.

Nevertheless, the influence of loss aversion on decision making can vary and is not applicable to all decisions. For example, when deciding on which flight to take, some decision makers, such as business travelers, choose the flight with the most convenient schedule. Another example is when choosing to purchase something needed immediately, such as sunburn spray, keeping options open is not relevant if you have a painful sunburn. Additionally, when faced with many choices of an inexpensive item, many people decide not to make a choice (e.g., an experiment showed that more people made a purchase when choosing among only a few jams than when there was a selection of many jams). In some cases, it is important to keep an option available; that is, to keep the door open. In many other cases, it can be costly and unnecessary.

A system and method for predicting a decision maker's desire to keep the door open and, secondarily, to advise the decision maker on how likely the option will be useful is desired. Some aspects of the present disclosure are directed to a system and method that predicts a user's “loss aversion” when making a purchase and makes recommendations based on the predicted loss aversion. In some aspects of the present disclosure, a method may include examining social media for comments about features that a purchaser wishes for in their product. Features that a purchaser commonly expresses that they would like after purchasing a product are unlikely to be features characteristic of a door (feature) that one might want to keep open. The method may include examining a purchaser's feature choices by comparing features of past purchases to new purchases to provide insight to what features matter. For example, if a user previously purchased a car with a sunroof but their next car does not have a sunroof, a sunroof may have been purchased on the first car to keep the door open.

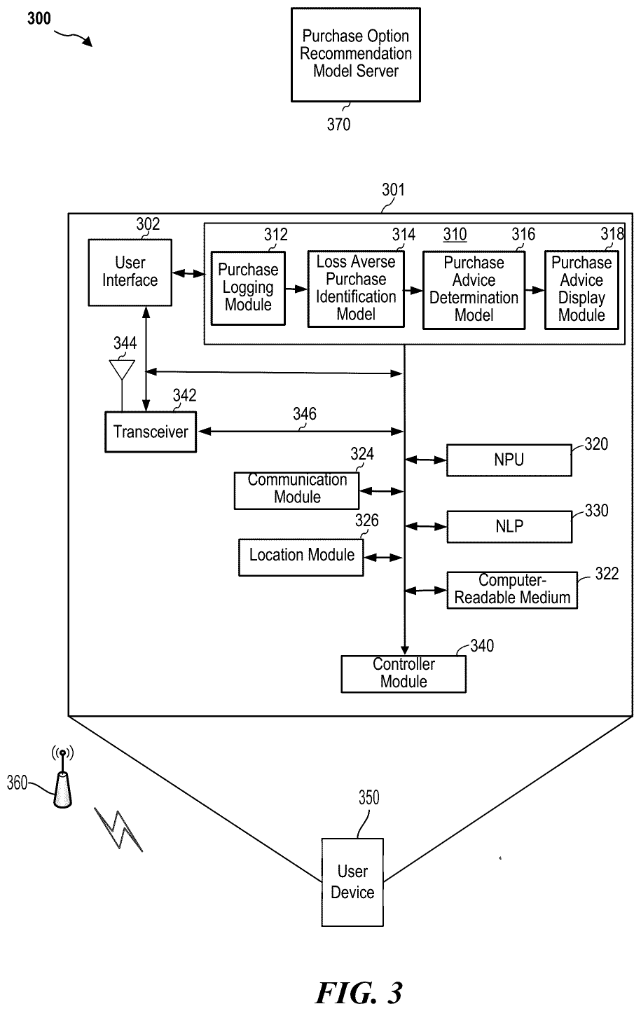

FIG. 3 is a diagram illustrating a hardware implementation for a purchase monitoring and recommendation system 300, according to aspects of the present disclosure. The purchase monitoring and recommendation system 300 may be configured to monitor user purchase making activity. The purchase monitoring and recommendation system 300 may be configured to log a user purchase and purchase communications corresponding to an option purchased by the user. Additionally, the purchase monitoring and recommendation system 300 is configured to identify whether loss aversion was a factor in a purchase making process of the user purchase of the option. In some aspects of the present disclosure, the purchase monitoring and recommendation system 300 may be configured to generate a purchase recommendation based on the average use of the option in response to identifying that loss aversion is a factor in the decision-making process of the user purchase of the option.

The purchase monitoring and recommendation system 300 includes a user monitoring system 301 and a purchase option recommendation model server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The purchase option recommendation model server 370 may connect to the user device 350 for providing purchase option recommendations. For example, the purchase option recommendation model server 370 may advise the decision maker on how likely the option will be useful in response to predicting a decision maker's desire to keep the door open. Aspects of the present disclosure recognize there are different dimensions that can influence whether a decision maker will want to keep the door open. For some of the dimensions, loss aversion is a factor, while it is not for others. In some aspects of the present disclosure, a set of dimensions involved in decision making are identified. In this aspect of the present disclosure, a model is created that takes the choices as input and uses values for the applicable dimensions as input. The model then predicts the strength of a desire to keep the door open. If there is a strong desire to keep the door open, then the purchase option recommendation model server 370 presents an average use of the option to the decision maker. Some aspects of the present disclosure are directed to several complementary data analysis methods to identify a set of dimensions related to whether loss aversion is a factor in a purchase decision.

The user monitoring system 301 may be implemented with an interconnected architecture, represented generally by an interconnect 346. The interconnect 346 may include any number of point-to-point interconnects, buses, and/or bridges depending on the specific application of the user monitoring system 301 and the overall design constraints. The interconnect 346 links together various circuits including one or more processors and/or hardware modules, represented by a user interface 302, a purchase activity module 310, a neutral network processor (NPU) 320, a computer-readable medium 322, a communication module 324, a location module 326, a natural language processor (NLP) 330, and a controller module 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the purchase activity module 310, the NPU 320, the computer-readable medium 322, the communication module 324, the location module 326, the NLP 330, and the controller module 340. The transceiver 342 is coupled to an antenna 344. The transceiver 342 communicates with various other devices over a transmission medium. For example, the transceiver 342 may receive commands via transmissions from a user or a connected vehicle. In this example, the transceiver 342 may receive/transmit information for the purchase activity module 310 to/from connected devices within the vicinity of the user device 350.

The user monitoring system 301 includes the NPU 320 coupled to the computer-readable medium 322. The NPU 320 performs processing, including the execution of software stored on the computer-readable medium 322 to provide a neural network model for user monitoring and advice recommendation functionality according to the present disclosure. The software, when executed by the NPU 320, causes the user monitoring system 301 to perform the various functions described for purchase monitoring and advice recommendation through the user device 350, or any of the modules (e.g., 310, 324, 326, 330, and/or 340). The computer-readable medium 322 may also be used for storing data that is manipulated by the NLP 330 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the autonomous vehicle 350 and/or the location module 326 compliant with the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC. LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the NLP 330 to receive and analyze language from a data log of purchase communications regarding a purchase option by the user. For example, the purchase communications may indicate whether loss aversion was a factor in the purchase making process of the option purchased by the user. In some aspects of the present disclosure, the data log may use natural language processing of the NLP 330 to extract terms from communications regarding risk averse user purchases, such as terms revealing that the user is keeping the door open by purchasing the option. For example, the user may have a tendency to invest time and money to keep their options open, even when the options have little interest or are unlikely to be used. This behavior may be attributed to loss aversion.

In aspects of the present disclosure, the NLP 330 is used if the communications are conducted in plain text. The user monitoring system 301, however, may receive and analyze the data log to determine the user's concerns around a purchase decision, such as compromises, risk, and costs. In these aspects of the present disclosure, the communications are a sequence of data logs (e.g., iterative searching process, selected filters, questionnaires). These communications may not be text but can be useful data to help determine a user purchase involving risk aversion using predictive analytics. These aspects of the present disclosure analyze non-language communications (e.g., those mentioned above) using machine-learning models to determine factors in a user purchase process.

The purchase activity module 310 may be in communication with the user interface 302, the NPU 320, the computer-readable medium 322, the communication module 324, the location module 326, the NLP 330, the controller module 340, and the transceiver 342. In one configuration, the purchase activity module 310 monitors communications from the user interface 302. The user interface 302 may monitor user communications to and from the communication module 324. According to aspects of the present disclosure, the NLP 330 may use natural language processing to extract terms from communications regarding user purchase, such as terms revealing that loss aversion was a factor in a user purchase process.

As shown in FIG. 3, the purchase activity module 310 includes a purchase logging module 312, a loss averse purchase identification model 314, a purchase advice determination model 316, and a purchase advice display module 318. The purchase logging module 312, the loss averse purchase identification model 314, and the purchase advice determination model 316 may be components of a same or different artificial neural network, such as a deep convolutional neural network (CNN). The purchase activity module 310 is not limited to a CNN. The purchase activity module 310 monitors and analyzes user purchase communications received from the user interface 302.

This configuration of the purchase activity module 310 includes the purchase logging module 312 for logging user purchase and purchase communications corresponding to an option purchased by the user through the user device 350. The purchase activity module 310 also includes the loss averse purchase identification model 314 for identifying whether loss aversion was a factor in a purchase making process of the user purchase of the option. The purchase activity module 310 also includes the purchase advice determination model 316 for determining a purchase recommendation in response to identifying that loss aversion is a factor in the purchase making process of the user purchase of the option. The purchase activity module 310 further includes the purchase advice display module 318 for displaying the purchase recommendation based on a determined use level of the option purchased of the user.

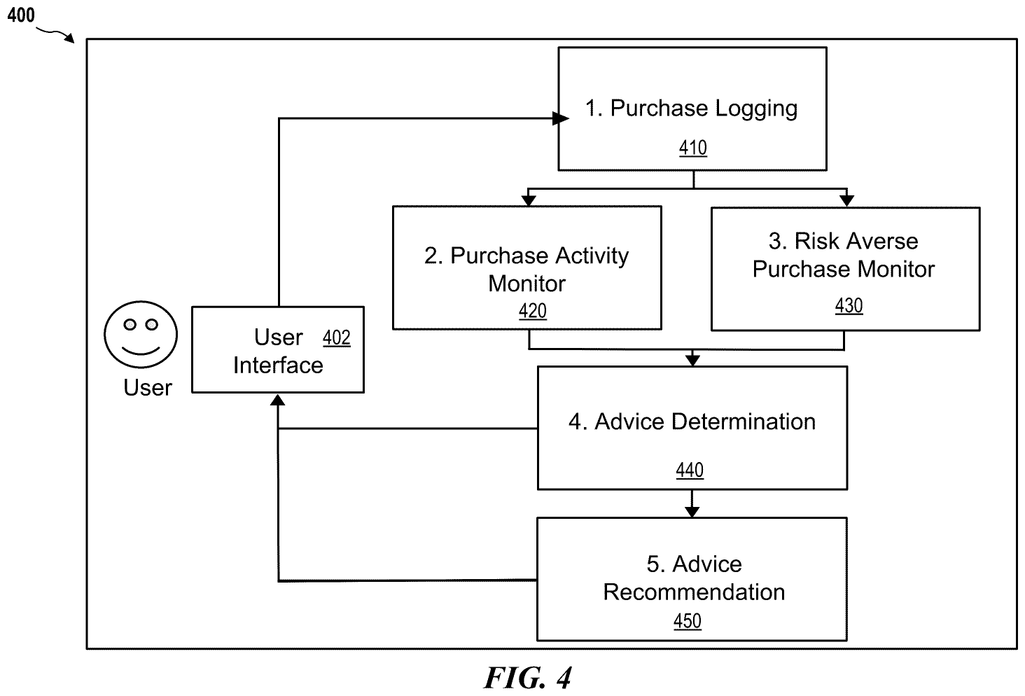

In some aspects of the present disclosure, the purchase advice determination model 316 determines a user frequency of an option the user is considering purchasing. After deploying the recommendation, the purchase monitoring and recommendation system 300 continues to monitor the user's purchase communications to determine an effectiveness of the recommendation. In some aspects of the present disclosure, data from the purchase logging module 312 are used as training data to tune the loss averse purchase identification model 314 and the purchase advice determination model 316. In some aspects of the present disclosure, the purchase advice determination model 316 may be implemented and/or work in conjunction with the purchase option recommendation model server 370, for example, as shown in FIG. 4.

FIG. 4 is a block diagram illustrating a purchase monitoring and recommendation system 400, in accordance with aspects of the present disclosure. In some aspects of the present disclosure, a purchase monitoring and recommendation system 400 logs data regarding potential purchases that a user may make. In this configuration, the purchase monitoring and recommendation system 400 includes a user interface 402, a purchase logging component 410, a purchase activity monitor 420, a risk averse purchase monitor 430, an advice determination component 440, and an advice recommendation component 450.

In this example, the purchase monitoring and recommendation system 400 provides a system/method for predicting a decision maker's desire to keep the door open and, secondarily, to advise the decision maker on how likely the option will be useful. Aspects of the present disclosure recognize that there are different dimensions that can influence whether a decision maker will unnecessarily want to keep the door open for a purchase option. For some of the dimensions, loss aversion is a factor, while it is not for others. In some aspects of the present disclosure, a set of dimensions involved in decision making are first identified. A model of the risk averse purchase monitor 430 is created, which takes the choices and uses values for the applicable dimensions as input. The model of the risk averse purchase monitor 430 then predicts the strength of a desire to keep the door open. If the risk averse purchase monitor 430 predicts a strong desire to keep the door open, then the advice determination component 440 may select the average use of the option, which can be presented to the decision maker through the advice recommendation component 450.

In some aspects of the present disclosure, the purchase monitoring and recommendation system 400 utilizes various data analysis methods to identify a set of dimensions related to whether loss aversion is a factor. For example, the purchase logging component 410 may log social media for comments about features that a purchaser wishes for in their product. The features that a purchaser commonly expresses that they would like after purchasing a product are unlikely to be features characteristic of a door (feature) that one might want to keep open. The purchase activity monitor 420 and the risk averse purchase monitor 430 may examine a purchaser's feature choices by comparing features of past purchases versus new purchases to provide insight to what features matter. For example, if the user purchased a car with a sunroof and the user's next car does not have a sunroof, a sunroof may have been purchased for the first car to keep the door open.

In some aspects of the present disclosure, the purchase logging component 410 logs purchaser's feedback about feature deletion. The purchase activity monitor 420 and/or the risk averse purchase monitor 430 may examine logged information from another source of information, such as when a feature is removed from a product, the complaints in reviews about a product about the missing feature can be analyzed. If the missing feature was an option and there are few complaints about its removal, then the missing feature was likely needlessly purchased to keep the door open. The greater the number of complaints and the stronger the sentiment, the more likely the feature is associated with a dimension of loss aversion, and one would want to keep the door open.

The purchase activity monitor 420 and/or the risk averse purchase monitor 430 may examine logged information regarding social media for comments about a feature when it is introduced. For example, many positive comments about a feature may indicate that a potential purchaser is more likely to consider the feature as something for which they would like to keep the door open so that they have the option to try out the new feature. Additionally, the purchase activity monitor 420 and/or the risk averse purchase monitor 430 may examine logged information regarding a purchaser's use of a feature. For example, another source of information is when the use of a feature is available for analysis after purchase. For example, one version of a fitness tracker may offer a feature that indicates how long and how well a user slept, while a more inexpensive version does not. For individuals that opt to purchase the fitness tracker with the sleep monitor, examination of how often the feature is used and whether it is used a month or so after purchase can indicate whether the feature was used to keep the door open. Some other dimensions that the purchase activity monitor 420 and/or the risk averse purchase monitor 430 may examine is logged information regarding the number of choices, or extenuating circumstances, such as the need to immediately make a decision, could be directly included without the need to analyze data.

In some aspects of the present disclosure, a prediction model of the risk averse purchase monitor is trained as follows. Once estimates are computed for how often purchasers “kept the door open” for the features associated with different products, the input from the different estimates can be combined in a statistical model of the risk averse purchase monitor 430 to predict the probability of a potential purchaser keeping the door open on different features. In some aspects of the present disclosure, the statistical model of the risk averse purchase monitor 430 is a machine-learning model trained on the collected data.

In practice, the desire to keep the door open is generally for more expensive products that are kept for a while, such as cars, or lifestyle products, such as sports equipment. The desire generally does not apply to products that are inexpensive or frequently bought. Products can be classified by the purchase activity monitor 420 to identify those that are of the type where the door is often kept open. Another feature of products where the door may be kept open is that the products have options and features. This information can be gleaned from logged information regarding sources that list tables of features, such as broadband packages, cars, and tables comparing features for some products (e.g., air fryer toaster ovens on websites).

As shown in FIG. 4, the purchase logging component 410 may log of purchases and communications by others of a potential option available for purchase by the user. Additionally, the purchase logging component 410 may log the purchases that others as well as the user make and the contexts surrounding the purchases to generate a data log. For example, the contexts may include scenarios, environments, user concerns, user compromises, user confidence and affects, and other information relating to the purchase. The purchase activity monitor 420 may receive and analyze the data log to determine others as well as the user's purchase activity. For example, the data log may use natural language processing (e.g., the NLP 330) to extract terms from communications from the purchase decision, in which the terms reveal whether the purchase may involve risk aversion. While the purchase activity monitor 420 is performing analysis of the data log, the risk averse purchase monitor 430 may receive and analyze the data log to predict whether risk aversion was involved in the user's potential purchase. For example, the data log may use the NLP 330 to extract terms from communications regarding a potential purchase decision. In this example, risk averse purchases may involve terms that reveal risk aversion was involved in the user's potential purchasing process.

In some aspects of the present disclosure, the advice determination component 440 may receive the results from the purchase activity monitor 420 and the risk averse purchase monitor 430 to determine an advice recommendation. The advice determination component 440 may generate an output corresponding to whether the user's purchase involved risk aversion. For example, based on statistics collected from the various information sources, the appropriate advice may include a frequency that an option available for purchase by the user is used to decision makers likely to unnecessarily keep the door open. In some aspects of the present disclosure, the advice recommendation component 450 provides the frequency information to the user as an alert.

According to aspects of the present disclosure, the risk averse purchase monitor 430 and/or the advice determination component 440 are implemented using a trained machine-learning model. For example, the risk averse purchase monitor 430 and/or the advice determination component 440 are implemented using a machine-learning model trained as follows. Once estimates are computed for how often purchasers “kept the door open” for the features associated with different products, the input from the different estimates can be combined in a statistical model of the risk averse purchase monitor 430 to predict the probability of a potential purchaser keeping the door open on different features. In some aspects of the present disclosure, the statistical model of the risk averse purchase monitor 430 is a machine-learning model trained on the collected data.

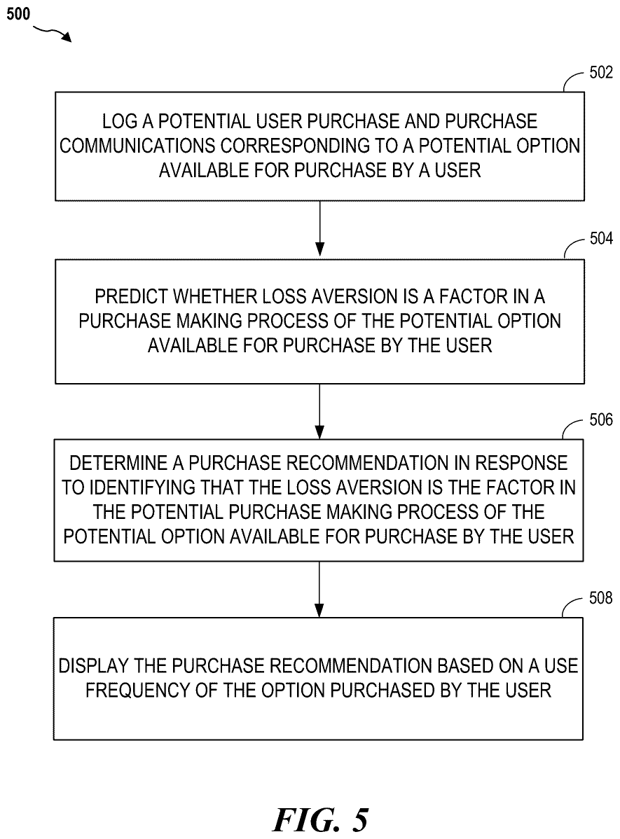

The advice recommendation component 450 may connect to the user interface 402 to provide an advice recommendation for the user. For example, the advice recommendation component 450 may recommend appropriate advice to decision makers. In some aspects of the present disclosure, based on the statistics collected for each of the information sources by the purchase logging component 410, the frequency that an option is used can be presented to decision makers likely to unnecessarily keep the door open. The user interface 402 may provide the option frequency to the user in the form of an alert to decision makers likely to unnecessarily keep the door open. The purchase monitoring and recommendation system 400 may engage in a process, for example, as shown in FIG. 5.

FIG. 5 is a flowchart illustrating a method for monitoring user purchase making activity, according to aspects of the present disclosure. A method 500 begins at block 502, in which a potential user purchase and purchase communications are logged corresponding to a potential option available for purchase by a user. For example, as shown in FIG. 4, the purchase logging component 410 may log social media for comments about features that a purchaser wishes for in their product. The features that a purchaser commonly expresses that they would like after purchasing a product are unlikely to be features characteristic of a door (feature) that one might want to keep open.

At block 504, a prediction is performed as whether loss aversion is a factor in a purchase making process of the potential option available for purchase by the user. For example, as shown in FIG. 4, The purchase activity monitor 420 may receive and analyze the data log to determine others as well as the user's purchase activity. For example, the data log may use natural language processing (e.g., the NLP 330) to extract terms from communications from purchase decisions, in which the terms reveal whether the potential purchase may involve risk aversion. While the purchase activity monitor 420 is performing analysis of the data log, the risk averse purchase monitor 430 may receive and analyze the data log to predict whether risk aversion was involved in the user's potential purchase. For example, the data log may use the NLP 330 to extract terms from communications regarding a potential purchase decision. In this example, risk averse purchases may involve terms that reveal risk aversion was involved in the user's potential purchasing process.

At block 506, a purchase recommendation is determined in response to identifying that the loss aversion is the factor in the potential purchase making process of the potential option available for purchase by the user. For example, as shown in FIG. 4, the advice determination component 440 may generate an output corresponding to whether the user's purchase involved risk aversion. For example, based on statistics collected from the various information sources, the appropriate advice may include a frequency that an option available for purchase by the user is used to decision makers likely to unnecessarily keep the door open. At block 508, the purchase recommendation based on a use frequency of the option available for purchase by the user is displayed.

The method 500 include logging of purchases and communications by others of the potential option available for purchase by the user. The method 500 may perform training of a machine-learning model to predict whether the loss aversion is the factor in the purchase making process for the option purchased by the user and to advise the user on how likely the option purchased by the user is useful. The method 500 may further perform training of the machine-learning model by examining social media comments regarding the option purchased of the user. The method 500 may also perform training of the machine-learning model by examining the user's purchase history. The method 500 may further perform training of the machine-learning model by examining the use of the option purchased by the user by others that purchased the option. The method 500 may also perform training of the machine-learning model by examining the purchaser's feedback on removal of the option purchased by the user. The method 500 may further perform training of the machine-learning model by identifying a set of dimensions involved in the purchase making process. The method 500 may also include inputting, into the machine-learning model, the set of dimensions and values for the set of dimensions. The method 500 may further include predicting, by the machine-learning model, a strength of the loss aversion by the user.

A system and method for predicting a decision maker's desire to keep the door open and, secondarily, to advise the decision maker on how likely the option will be useful is desired. Some aspects of the present disclosure are directed to a system and method that predicts a user's “loss aversion” when making a purchase and makes recommendations based on the predicted loss aversion. In some aspects of the present disclosure, a method may include examining social media for comments about features that a purchaser wishes for in their product. Features that a purchaser commonly expresses that they would like after purchasing a product are unlikely to be features characteristic of a door (feature) that one might want to keep open. The method may include examining a purchaser's feature choices by comparing features of past purchases to new purchases to provide insight to what features matter. For example, if a user previously purchased a car with a sunroof but their next car does not have a sunroof, a sunroof may have been purchased on the first car to keep the door open.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing. including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for monitoring user purchase making activity, comprising:
logging a potential user purchase and purchase communications corresponding to a potential option available for purchase by a user;
predicting whether loss aversion is a factor in a purchase making process of the potential option available for purchase by the user;
determining a purchase recommendation in response to identifying that the loss aversion is the factor in the potential purchase making process of the potential option available for purchase by the user; and
displaying the purchase recommendation based on a use frequency of the option purchased by the user.

2. The method of claim 1, further comprising:
logging of purchases and communications by others of the potential option available for purchase by the user; and
training a machine-learning model to predict whether the loss aversion is the factor in the potential purchase making process of the potential option available for purchase by the user and to advise the user on how likely the option purchased by the user is useful.

3. The method of claim 2, in which training the machine-learning model comprises examining social media comments regarding the potential option available for purchase by the user.

4. The method of claim 2, in which training the machine-learning model comprises examining a purchase history of the user.

5. The method of claim 2, in which training the machine-learning model comprises:
examining use of the potential option available for purchase by the user by others that purchased the option; and
examining feedback by others that purchased the option on removal of the potential option available for purchase by the user.

6. The method of claim 2, in which training the machine-learning model comprises:
identifying a set of dimensions involved in the potential purchase making process of the potential option available for purchase by the user;
inputting, into the machine-learning model, the set of dimensions and values for the set of dimensions; and
predicting, by the machine-learning model, a strength of the loss aversion by the user.

7. The method of claim 1, in which predicting whether the loss aversion was the factor comprises:
analyzing, using a natural language processor, terms of the purchase communications of the user to predict whether the loss aversion was the factor; and
analyzing, using a machine-learning model, how often purchasers incurred the loss aversion for options associated with different products.

8. The method of claim 1, in which logging the potential user purchase comprises compiling contexts surrounding the potential user purchase to generate a data log, in which the contexts comprise scenarios, environments, concerns of the user, and/or information relating to the potential user purchase.

9. A non-transitory computer-readable medium having program code recorded thereon for monitoring user purchase making activity, the program code being executed by a processor and comprising:
program code to log a potential user purchase and purchase communications corresponding to a potential option available for purchase by the user;
program code to predict whether loss aversion is a factor in a purchase making process of the potential option available for purchase by the user;
program code to determine a purchase recommendation in response to identifying that the loss aversion is the factor in the potential purchase making process of the potential option available for purchase by the user; and
program code to display the purchase recommendation based on a use frequency of the option purchased by the user.

10. The non-transitory computer-readable medium of claim 9, further comprising:
program code to log of purchases and communications by others of the potential option available for purchase by the user; and
program code to train a machine-learning model to predict whether the loss aversion is the factor in the potential purchase making process of the potential option available for purchase by the user and to advise the user on how likely the option purchased by the user is useful.

11. The non-transitory computer-readable medium of claim 10, in which the program code to train the machine-learning model comprises program code to examine social media comments regarding the potential option available for purchase by the user.

12. The non-transitory computer-readable medium of claim 10, in which the program code to train the machine-learning model comprises program code to examine a purchase history of the user.

13. The non-transitory computer-readable medium of claim 10, in which the program code to train the machine-learning model comprises:
program code to examine use of the potential option available for purchase by the user by others that purchased the option; and
program code to examine feedback by others that purchased the option on removal of the potential option available for purchase by the user.

14. The non-transitory computer-readable medium of claim 10, in which the program code to train the machine-learning model comprises:
program code to identify a set of dimensions involved in the potential purchase making process of the potential option available for purchase by the user;
program code to input, into the machine-learning model, the set of dimensions and values for the set of dimensions; and
program code to predict, by the machine-learning model, a strength of the loss aversion by the user.

15. The non-transitory computer-readable medium of claim 9, in which the program code to predict whether the loss aversion was the factor comprises:
program code to analyze, using a natural language processor, terms of the purchase communications of the user to predict whether the loss aversion was the factor; and
program code to analyze, using a machine-learning model, how often purchasers incurred the loss aversion for options associated with different products.

16. The non-transitory computer-readable medium of claim 9, in which the program code to log the potential user purchase comprises program code to compile contexts surrounding the potential user purchase to generate a data log, in which the contexts comprise scenarios, environments, concerns of the user, and/or information relating to the potential user purchase.

17. A system for monitoring user purchase making activity, the system comprising:
a purchase logging module to log a potential user purchase and purchase communications corresponding to a potential option available for purchase by the user;
a loss averse purchase identification model to predict whether loss aversion is a factor in a purchase making process of the potential option available for purchase by the user;
a purchase advice determination model to determine a purchase recommendation in response to identifying that the loss aversion is the factor in the potential purchase making process of the potential option available for purchase by the user; and
a purchase advice display module to display the purchase recommendation based on a use frequency of the option purchased by the user.

18. The system of claim 17, further comprising a machine-learning model trained to predict whether the loss aversion is the factor in the potential purchase making process of the potential option available for purchase by the user and to advise the user on how likely the option purchased by the user is useful according to logged purchases and communications by others of the potential option available for purchase by the user.

19. The system of claim 17, in which the loss averse purchase identification model is further to analyze, using a natural language processor, terms of the purchase communications of the user to predict whether the loss aversion was the factor, and to analyze, using a machine-learning model, how often purchasers incurred the loss aversion for options associated with different products.

20. The system of claim 17, in which the purchase logging module is further to compile contexts surrounding the potential user purchase to generate a data log, in which the contexts comprise scenarios, environments, concerns of the user, and/or information relating to the potential user purchase.
